(19) United States
(12) Patent Application Publication
(10) Pub. No.: US 2025/0342788 A1
(43) Pub. Date: Nov. 6, 2025

(54) ELECTRONIC APPARATUS AND LIGHTING EFFECT CONTROL METHOD THEREOF

(71) Applicant: Acer Incorporated, New Taipei City (TW)

(72) Inventor: Kuan-Ju Chen, New Taipei City (TW)

(73) Assignee: Acer Incorporated, New Taipei City (TW)

(21) Appl. No.: 19/194,010

(22) Filed: Apr. 30, 2025

(30) Foreign Application Priority Data
May 3, 2024 (TW) 113116593

(51) Int. Cl. G09G 3/20; G06F 3/02; H05B 47/11

(52) U.S. Cl. CPC G09G 3/2003; G06F 3/021; H05B 47/11; G09G 2320/0666; G09G 2340/0407; G09G 2354/00; G09G 2360/141; G09G 2360/18

(57) ABSTRACT

Disclosed are an electronic apparatus and a lighting effect control method thereof. The method is adaptable for an electronic apparatus including a light-emitting apparatus and includes the following steps. Pixel data of a display frame of a display apparatus is captured from an image buffer. Light-emitting color data respectively corresponding to multiple light-emitting elements of the light-emitting apparatus is determined according to the pixel data of the display frame. Each of the light-emitting elements of the light-emitting apparatus is controlled to emit light according to the light-emitting color data of each of the light-emitting elements.

### CROSS-REFERENCE TO RELATED APPLICATION

This application claims the priority benefit of Taiwan application serial no. 113116593, filed on May 3, 2024. The entirety of the above-mentioned patent application is hereby incorporated by reference herein and made a part of this specification.

### BACKGROUND

### Technical Field

The disclosure relates to an electronic apparatus, and in particular to an electronic apparatus and a lighting effect control method thereof.

### Description of Related Art

The keyboard is an indispensable equipment for some electronic apparatuses, allowing users to input relevant information. In recent years, keyboards have become more than just the equipment for users to input information. In order to meet requirements of users for sound and light effects, various manufacturers have equipped lighting modules in keyboards to provide diverse and dazzling lighting effects. Currently, the lighting effect settings of keyboards on the market can be manually adjusted by users, but the operation is cumbersome and may not necessarily achieve the desired results. In addition, different users have personal preferences and user habits, so a single lighting effect control method is not suitable for all users.

### SUMMARY

In view of this, the disclosure provides an electronic apparatus and a lighting effect control method thereof, which can solve the aforementioned technical problems.

An embodiment of the disclosure provides a lighting effect control method, which is adaptable for an electronic apparatus including a light-emitting apparatus. The method includes the following steps. Pixel data of a display frame of a display apparatus is captured from an image buffer. Light-emitting color data respectively corresponding to multiple light-emitting elements of the light-emitting apparatus is determined according to the pixel data of the display frame. Each of the light-emitting elements of the light-emitting apparatus is controlled to emit light according to the light-emitting color data of each of the light-emitting elements.

An embodiment of the disclosure provides an electronic apparatus including a display apparatus, a light-emitting apparatus, a storage apparatus, and a processor. The light-emitting apparatus has multiple light-emitting elements. The storage apparatus records multiple commands. The processor is coupled to the display apparatus, the light-emitting apparatus, and the storage apparatus, and is configured to execute the aforementioned commands and the following operation. Pixel data of a display frame of the display apparatus is captured from an image buffer. Light-emitting color data respectively corresponding to multiple light-emitting elements of the light-emitting apparatus is determined according to the pixel data of the display frame. Each of the light-emitting elements of the light-emitting apparatus is controlled to emit light according to the light-emitting color data respectively corresponding to each of the light-emitting elements.

Based on the above, according to the embodiments of the disclosure, the pixel data of the display frame may be retrieved from the image buffer, and the light-emitting color data of each light-emitting element disposed on the light-emitting apparatus may be determined according to the pixel data of the display frame. Each light-emitting element generates color light according to the corresponding light-emitting color data, so that the lighting effect color of the light-emitting apparatus may be matched with a display image of the display apparatus. Based on this, the light-emitting apparatus may provide corresponding lighting effects based on the operating scenarios of the user, which greatly improves the user experience.

### BRIEF DESCRIPTION OF THE DRAWINGS

FIG. 1 is a block diagram of an electronic apparatus according to an embodiment of the disclosure.

FIG. 2 is a schematic diagram of a light-emitting keyboard according to an embodiment of the disclosure.

FIG. 3 is a flow chart of a lighting effect control method according to an embodiment of the disclosure.

FIG. 4 is a flow chart of capturing pixel data of a display frame according to an embodiment of the disclosure.

FIG. 5 is a schematic diagram of capturing pixel data of a display frame according to an embodiment of the disclosure.

FIG. 6 is a flow chart of a lighting effect control method according to an embodiment of the disclosure.

FIG. 7 is a flow chart of updating a model according to an embodiment of the disclosure.

FIG. 8 is a flow chart of a lighting effect control method according to an embodiment of the disclosure.

FIG. 9 is a flow chart of determining light-emitting color data of a light-emitting element according to an embodiment of the disclosure.

### DESCRIPTION OF THE EMBODIMENTS

A portion of the embodiments of the disclosure is described in detail hereinafter with reference to figures. In the following, the same reference numerals in different figures should be considered to represent the same or similar elements. These embodiments are only a portion of the disclosure and do not disclose all of the possible implementations of the disclosure. More precisely, these embodiments are only examples in the claims of the disclosure.

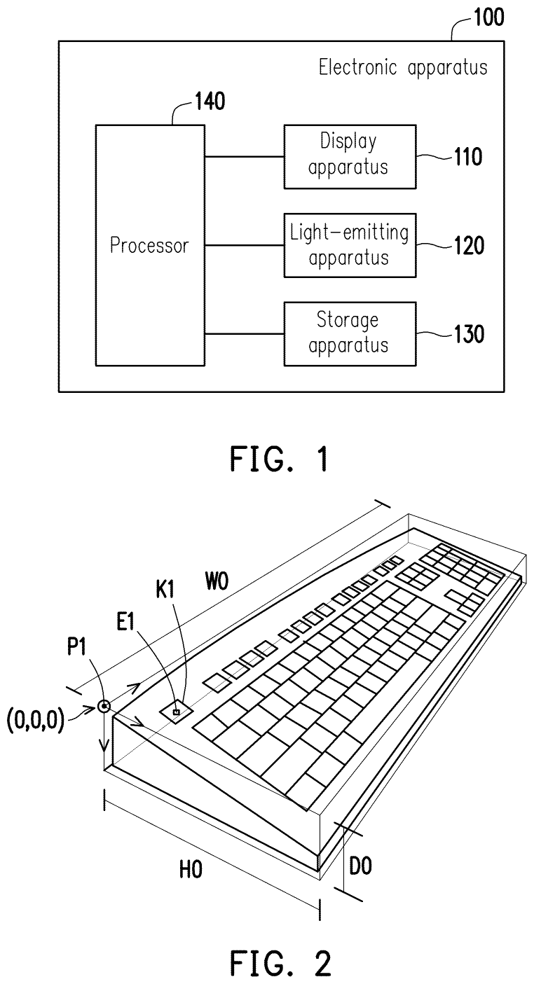

FIG. 1 is a block diagram of an electronic apparatus according to an embodiment of the disclosure. Referring to FIG. 1, an electronic apparatus 100 includes a display apparatus 110, a light-emitting apparatus 120, a storage apparatus 130, and a processor 140. The electronic apparatus 100 is, for example, a tablet computer, a notebook computer, a desktop computer, and an all-in-one computer, but the disclosure is not limited thereto.

The display apparatus 110 is, for example, a liquid crystal display (LCD), a light-emitting diode (LED) display, an organic light-emitting diode (OLED) display, or other kinds of displays, but the disclosure is not limited thereto.

The light-emitting apparatus 120 has multiple light-emitting elements and may display different lighting effects. The aforementioned light-emitting elements may be LEDs. In some embodiments, these light-emitting elements may include RGB LEDs, monochromatic LEDs, or a combination thereof. In some embodiments, the light-emitting apparatus 120 may include a light-emitting keyboard supporting human interface device (HID) specifications. The light-emitting apparatus 120 may be built in the electronic apparatus 100 or externally connected to the electronic apparatus 100, but the disclosure is not limited thereto. Alternatively, in some embodiments, the light-emitting apparatus 120 may also include a light-emitting mouse, a light-emitting fan, a light-emitting memory module, a light-emitting touch panel, a light-emitting motherboard, and so on, but the disclosure is not limited thereto.

Taking the light-emitting apparatus 120 as an example of a light-emitting keyboard, the user may operate, control, or input information to the electronic apparatus 100 by the light-emitting keyboard. The light-emitting keyboard may be composed of multiple key structures. The keycaps of each key structure may move up and down as the user presses or releases the keycaps, and the keycaps may be light-transmitting or opaque. In addition, for different keyboard types, in order to guide the keycaps to move up and down, a supporting structure of the key structure may include a spring or a scissor-foot mechanism, but the disclosure is not limited thereto. The light-emitting elements may be placed under the keycaps, so that the light-emitting keyboard may display lighting visual effects.

The storage apparatus 130 is configured to store data and software modules (such as operating systems, applications, and drivers) for access by the processor 140, and may be, for example, any type of a fixed or removable random access memory (RAM), a read-only memory (ROM), a flash memory, a hard disk, or a combination thereof.

The processor 140 is coupled to the display apparatus 110, the light-emitting apparatus 120, and the storage apparatus 130, and may be a general-purpose processor, a specific-purpose processor, a conventional processor, a digital signal processor, multiple microprocessors, one or more microprocessor combined with digital signal processor core, a controller, a microcontroller, application specific integrated circuits (ASICs), field programmable gate array (FPGAs), any other kind of integrated circuits, state machines, processors based on advanced RISC machine (ARM) and the like. The processor 140 may access and execute commands or program codes recorded in the storage apparatus 130 to implement a lighting effect control method according to the embodiments of the disclosure.

In some embodiments, the processor 140 may implement the lighting effect control method according to the embodiments of the disclosure by running the application in a user mode. The aforementioned application may include a lighting setting utility and multiple software program modules. The lighting setting utility may provide an intuitive and easy-to-operate graphical interface. In some embodiments, the user may adjust the lighting effect of the light-emitting apparatus 120 by the intuitive and easy-to-operate graphical interface. For example, the graphical interface may be configured to adjust the brightness, color, light-emitting frequency, or lighting effect mode of the light-emitting apparatus 120.

In some embodiments, the light-emitting apparatus 120 includes one or multiple light-emitting elements which may be directly controlled by the operating system. For example, the light-emitting apparatus 120 may support the lighting and illumination standard of the HID specifications released by Microsoft Corporation, so that an operating system of the electronic apparatus 100 may directly control the light-emitting element of the light-emitting apparatus 120. Based on the lighting and illumination standard of the HID specifications, each light-emitting element of the light-emitting apparatus 120 may correspond to a logical position according to an apparatus size of the light-emitting apparatus 120, and this logical position is used as an identification feature of the light-emitting apparatus. Since the operating system may directly control the light-emitting element of the light-emitting apparatus 120, the lighting effect control of the light-emitting apparatus 120 may be execute by the application in the user mode.

For example, FIG. 2 is a schematic diagram of a light-emitting keyboard according to an embodiment of the disclosure. Please refer to FIG. 2, taking the light-emitting apparatus 120 as an example of a light-emitting keyboard. The apparatus size of the light-emitting apparatus 120 is a width W0*, a height H0*, and a depth D0. A logical position of an origin P1 may be (0, 0, 0). Under this circumstance, each light-emitting element disposed in the light-emitting apparatus 120 may correspond to a unique logical position based on the origin P1. For example, a light-emitting element E1 under a key K1 may correspond to the logical position (W′, H′, D′). It may be seen that different light-emitting elements correspond to different logical locations. Therefore, the processor 140 may individually and directly control lighting parameters of these light-emitting elements according to the logical positions of these light-emitting elements. The lighting parameters may include color parameters, brightness parameters, lighting frequency parameters or other lighting control parameters.

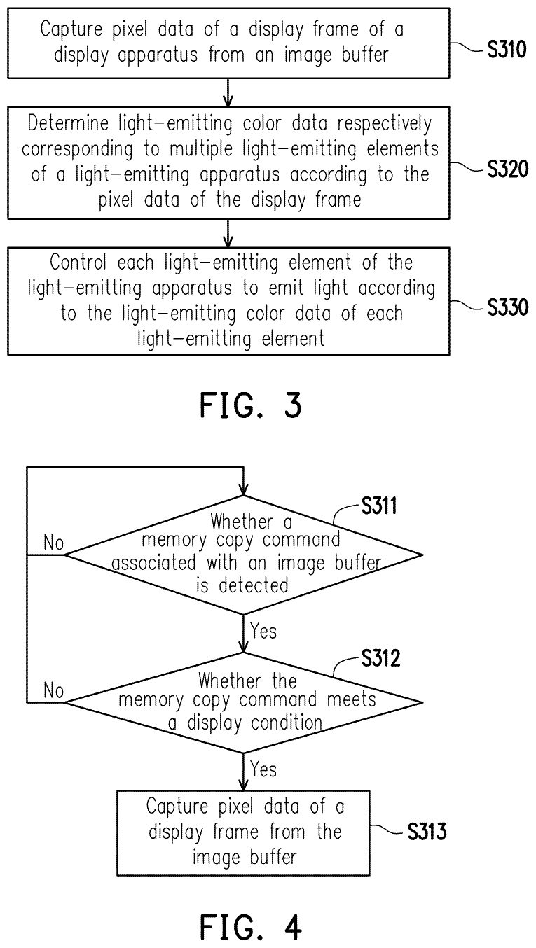

FIG. 3 is a flow chart of a lighting effect control method according to an embodiment of the disclosure, and the method flow of FIG. 3 may be implemented by each element of the electronic apparatus 100 in FIG. 1. Referring to FIG. 1 and FIG. 3 at the same time, a description of the steps of the lighting effect control method in this embodiment with reference to each element of the electronic apparatus 100 in FIG. 1 is as follows.

In step S310, the processor 140 captures pixel data of a display frame of the display apparatus 110 from an image buffer. Specifically, the image buffer is configured to cache the display frame which may be displayed by the display apparatus 110. The display frames is respectively composed of multiple pixels. In some embodiments, the pixel data of the display frame may be the RGB data of each pixel, that is, a red pixel value, a green pixel value, a the blue pixel value of each pixel of the display frame. In other embodiments, the pixel data of the display frame may be pixel values meeting other color formats, but the disclosure is not limited thereto. In different embodiments, the image buffer may be located in the memory accessed by a central processor (CPU) or by a graphics processor (GPU).

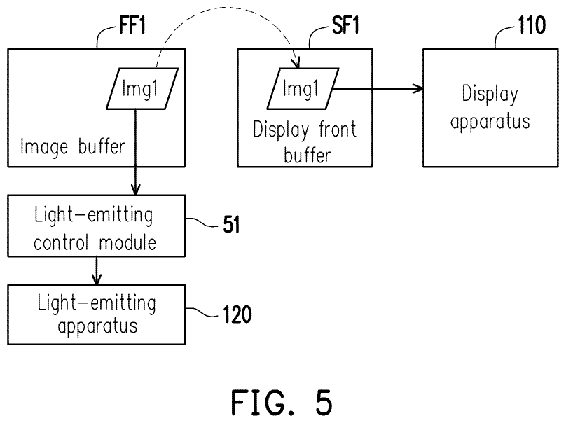

Please refer to FIG. 4, which is a flow chart of capturing pixel data of a display frame according to an embodiment of the disclosure. In some embodiments, step S310 of FIG. 3 may be implemented as step S311 to step S313 of FIG. 4. In addition, in order to clearly illustrate the principle of this embodiment, FIG. 5 is incorporated to facilitate comprehension of the following description. FIG. 5 is a schematic diagram of capturing pixel data of a display frame according to an embodiment of the disclosure.

It should be noted that in some embodiments, in response to generating a shader through a graphic API, the processor 140 may respectively create an image buffer FF1 and a display front buffer SF1 through the graphics API. The image buffer FF1 and the display front buffer SF1 are storage spaces configured to cache display data of the display apparatus 110. More specifically, in a process of running the shader by the GPU of the electronic apparatus 100 to render a display frame Img1, the pixel data of the display frame Img1 is written to the image buffer FF1 sequentially. Next, the complete display frame Img1 stored in the image buffer FF1 may be copied to the display front buffer SF1, and the display apparatus 110 displays the image according to the display frame Img1 recorded in the display front buffer SF1. The display front buffer SF1 is, for example, a swap chain cache. That is, when the display frame Img1 is copied to the display front buffer SF1, the display apparatus 110 displays the display frame Img1.

In step S311, the processor 140 determines whether a memory copy command associated with the image buffer FF1 is detected. That is, processor 140 detects the memory copy command associated with image buffer FF1. The memory copy command is configured to copy the display frame Img1 of the image buffer FF1 to other storage space.

If the determination in step S311 is yes, the processor 140 determines whether the memory copy command meets a display condition in step S312. According to a destination address indicated by the memory copy command, the processor 140 may determine whether the memory copy command meets the display condition. In some embodiments, the display condition may include that the destination address of the memory copy command is the display front buffer SF1. That is, the processor 140 determines whether the destination address of the memory copy command is the display front buffer SF1. In other words, when the memory copy command meets the display condition, the display frame Img1 of the image buffer FF1 is copied to the display front buffer SF1 in response to the memory copy command.

If the determination in step S312 is yes, in response to the memory copy command meeting the display condition, the processor 140 captures the pixel data of the display frame Img1 from the image buffer FF1 in step S313. In an example of FIG. 5, the processor 140 may run a light-emitting control module 51 to capture the pixel data of the display frame Img1 from the image buffer FF1. The light-emitting control module 51 may be a software program recorded in the storage apparatus 130. The light-emitting control module 51 may control the lighting effect color of the light-emitting apparatus 120 according to the pixel data of the display frame Img1, and the detailed implementation method is clearly described later. It should be noted that the determination is based on the light-emitting control module 51 capturing the pixel data of the display frame Img1 from the image buffer FF1 earlier, which may avoid an obvious delay between the lighting effect color of the light-emitting apparatus 120 and a display image to ensure that the lighting effect color of the light-emitting apparatus 120 may smoothly match the display image.

Returning to FIG. 3, in step S320, the processor 140 determines the light-emitting color data respectively corresponding to the light-emitting elements of the light-emitting apparatus 120 according to the pixel data of the display frame. In different embodiments, the light-emitting color data of each light-emitting element of the light-emitting apparatus 120 may be set to display pixel data of a corresponding pixel or statistical pixel data of multiple pixels of the display frame. The light-emitting color data of each light-emitting element may also include a red portion, a green portion, and a blue portion.

In some embodiments, the processor 140 may divide the display frame into multiple sub-pixel blocks and perform statistical operations (such as average operations) on the pixel data of each sub-pixel block. In this way, the processor 140 may obtain the average pixel data corresponding to each sub-pixel block on the display frame, and determine the light-emitting color data of each light-emitting element of the light-emitting apparatus 120 according to the average pixel data corresponding to each sub-pixel block. For example, the processor 140 may set the light-emitting color data of the light-emitting element located on a left side of the light-emitting apparatus 120 according to the average pixel data of the leftmost sub-pixel block on the display frame.

In some embodiments, the processor 140 may calculate a ratio parameter between the frame resolution of the display frame of the image buffer and the width and height of the light-emitting apparatus 120, and map the light-emitting elements of the light-emitting apparatus 120 to different pixels of the display frame according to the aforementioned ratio parameter. In this way, the processor 140 may set the light-emitting color data of each light-emitting element to the pixel data of the corresponding pixel on the display frame according to the aforementioned mapping results.

In some embodiments, the processor 140 may input the pixel data of the display frame into an inference model, and determine the light-emitting color data respectively corresponding to the light-emitting elements of the light-emitting apparatus 120 according to the output of the inference model. In some embodiments, the inference model may output the light-emitting color data of each light-emitting element.

Afterwards, in step S330, the processor 140 controls each light-emitting element of the light-emitting apparatus 120 to emit light according to the light-emitting color data of each light-emitting element. In some embodiments, after determining the light-emitting color data respectively corresponding to the light-emitting elements, the processor 140 may transmit the light-emitting color data to an embedded controller (EC) to control each light-emitting element of the light-emitting apparatus 120 to emit color light according to the corresponding light-emitting color data. In some embodiments, the processor 140 may transmit the light-emitting color data of each light-emitting element to the light-emitting apparatus 120 by the HID API.

Based on this, the lighting effect color displayed by the light-emitting apparatus 120 may be determined according to the display image of the display apparatus 110, so that the lighting effect color displayed by the light-emitting apparatus 120 may be consistent with the display image of the display apparatus 110. For example, when a game image displayed by the display apparatus 110 changes from a bright tone to a dark tone, the lighting effect color displayed by the light-emitting apparatus 120 may correspondingly change from a bright tone to a dark tone, so that the user feels stronger game atmosphere.

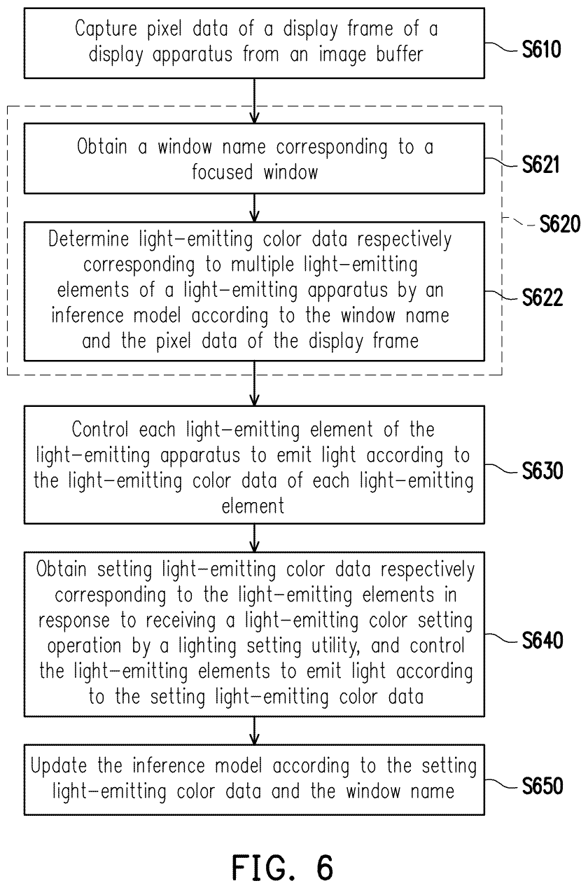

FIG. 6 is a flow chart of a lighting effect control method according to an embodiment of the disclosure, and the method flow of FIG. 6 may be implemented by each element of the electronic apparatus 100 in FIG. 1. Referring to FIG. 1 and FIG. 6 at the same time, a description of the steps of the lighting effect control method in this embodiment with reference to each elements of the electronic apparatus 100 in FIG. 1 is as follows.

In step S610, the processor 140 captures the pixel data of the display frame of the display apparatus 110 from the image buffer. The detailed implementation of step S610 may refer to the description of the foregoing embodiments, and is not repeated herein.

In step S620, the processor 140 determines the light-emitting color data respectively corresponding to the light-emitting elements of the light-emitting apparatus 120 according to the pixel data of the display frame. In this embodiment, step S620 may be implemented as step S621 to step S622.

In step S621, the processor 140 obtains a window name corresponding to a focused window. In some embodiments, the processor 140 may obtain the window name of the focused window focused on an input apparatus (such as a mouse or a keyboard) through an application programming interface (API) provided by the operating system (such as a Windows API function).

In step S622, the processor 140 determines the light-emitting color data respectively corresponding to the light-emitting elements of the light-emitting apparatus by the inference model according to the window name and the pixel data of the display frame. The processor 140 inputs the window name and the pixel data of the display frame to the inference model. Model parameters (such as weight data of neurons, and so on) of the inference model are stored in the storage apparatus 130. The inference model may include a deep learning model or a neural network model, and other artificial intelligence models which may be trained to autonomously execute specific tasks. For example, the inference model may include a convolutional neural network model (CNN model). In some embodiments, processor 140 may convert the window name into an index value and combine the index value with the pixel data of the display frame to generate model input data.

In some embodiments, the output of the inference model includes one or multiple two-dimensional matrices. That is, the light-emitting color data of the light-emitting elements may be expressed as the two-dimensional matrices. Multiple matrices in each two-dimensional matrix are color portions of the light-emitting elements respectively. For example, the inference model may output one two-dimensional matrix including red portions of the light-emitting elements. It is assumed that the width and the height of the light-emitting apparatus 120 are M unit lengths and N unit lengths respectively, a matrix size of the two-dimensional matrix corresponding to a color portion may be M*N. Each light-emitting element may correspond to one matrix of the two-dimensional matrix.

In step S630, the processor 140 controls each light-emitting element of the light-emitting apparatus 120 to emit the light according to the light-emitting color data of each light-emitting element. The detailed implementation of step S630 may refer to the description of the foregoing embodiments, and is not repeated herein.

In step S640, in response to receiving a light-emitting color setting operation by the lighting setting utility, the processor 140 obtains setting light-emitting color data respectively corresponding to the light-emitting elements, and controls the light-emitting elements to emit the light according to the setting light-emitting color data. The light-emitting color setting operation is a user operation issued by the user by the input apparatus. That is, when the light-emitting color data determined by the inference model does not meet the preference of the user, the user may manually adjust the lighting effect color of the light-emitting apparatus 120 by the lighting setting utility.

In step S650, the processor 140 updates the inference model according to the setting light-emitting color data and the window name. That is, the inference model is correspondingly updated or retrained according to the setting light-emitting color data determined by the user.

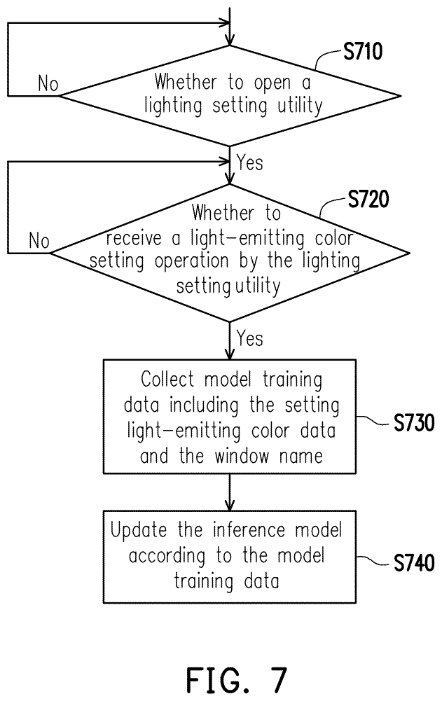

For example, FIG. 7 is a flow chart of updating a model according to an embodiment of the disclosure. Referring to FIG. 7, in some embodiments, step S650 may be implemented as step S710 to step S740.

In step S710, the processor 140 determines whether to open the lighting setting utility. If the determination in step S710 is yes, the processor 140 determines whether to receive a light-emitting color setting operation by the lighting setting utility in step S720. If the determination in step S720 is yes, the lighting effect color determined by the inference model does not meet the preference of the user.

If the determination in step S720 is yes, the processor 140 collects model training data including the setting light-emitting color data and the window name of each light-emitting elements in step S730. Specifically, the processor 140 may generate the setting light-emitting color data of each light-emitting element according to the light-emitting color setting operation received by the lighting setting utility. The setting light-emitting color data of the light-emitting elements may be expressed as the two-dimensional matrices. The user may issue user operations to the graphical interface of the lighting setting utility, so that the processor 140 obtains the setting light-emitting color data of each light-emitting element. For example, the user may set the lighting color of each light-emitting element of the light-emitting apparatus 120 by clicking a color wheel of the graphical interface of the lighting setting utility.

In step S740, the processor 140 updates the inference model according to the model training data. In some embodiments, in addition to the setting light-emitting color data and the window name set by the user, the model training data may further include the light-emitting color data originally output by the inference model based on the display frame. Therefore, the model parameters of the inference model may be updated according to a difference between the light-emitting color data originally output by the inference model and the setting light-emitting color data. The calculation of the loss value and the adjustment of the model weights regarding the model update may be accomplished by using any techniques well known to persons with ordinary knowledge in the art. The model update operation may be execute by the processor 140 or by a remote server.

It may be seen that the processor 140 may update the model parameters of the inference model according to the setting light-emitting color data of the light-emitting color setting operation. Therefore, the inference model may gradually learn the lighting effect color meeting the preferences of the user as the training data accumulates.

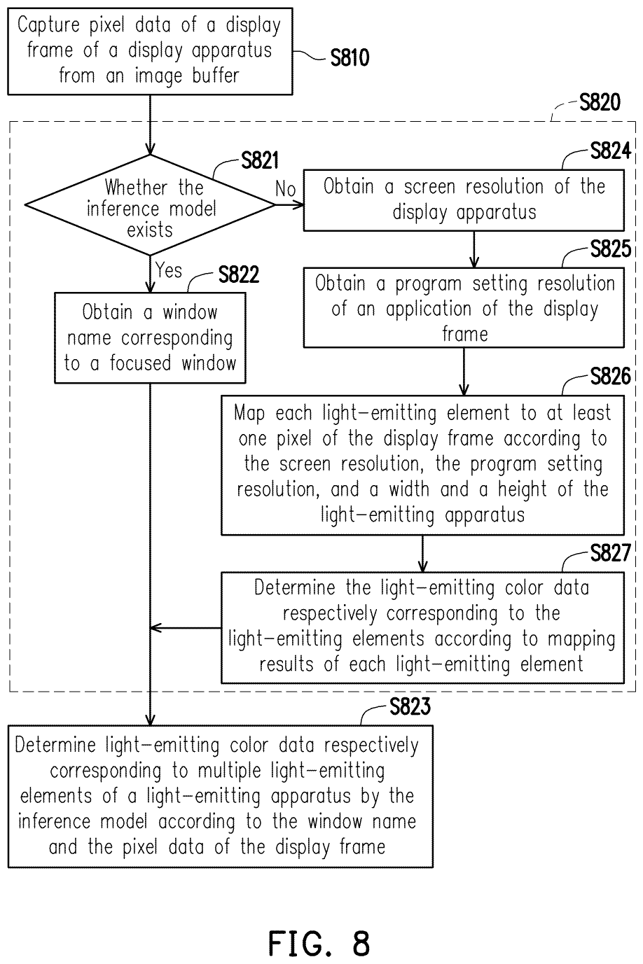

FIG. 8 is a flow chart of a lighting effect control method according to an embodiment of the disclosure, and the method flow of FIG. 8 may be implemented by each element of the electronic apparatus 100 in FIG. 1. Referring to FIG. 1 and FIG. 8 at the same time, a description of the steps of the lighting effect control method in this embodiment with reference to each element of the electronic apparatus 100 in FIG. 1 is as follows.

In step S810, the processor 140 captures the pixel data of the display frame of the display apparatus 110 from the image buffer. The detailed implementation of step S810 may refer to the description of the foregoing embodiments, and is not repeated herein.

In step S820, the processor 140 determines the light-emitting color data respectively corresponding to the light-emitting elements of the light-emitting apparatus 120 according to the pixel data of the display frame. In this embodiment, step S820 may be implemented as step S821 to step S827.

In step S821, the processor 140 determines whether the inference model exists. If the determination in step S821 is yes, the processor 140 obtains the window name corresponding to the focused window in step S822. In step S823, the processor 140 determines the light-emitting color data respectively corresponding to the light-emitting elements of the light-emitting apparatus by the inference model according to the window name and the pixel data of the display frame. The detailed implementation of steps S822 and S823 may refer to the description of the foregoing embodiments, and is not repeated herein.

If the determination in step S821 is no, the processor 140 obtains the screen resolution of the display apparatus 110 in step S824. The screen resolution of the display apparatus 110 is the number of pixels which may be displayed by the display apparatus 110. In step S825, the processor 140 obtains the program setting resolution of the application of the display frame. Here, the program setting resolution may be the frame resolution of the display frame of the image buffer. In some embodiments, the application may provide a function that allows the user to set the screen resolution. Based on the program setting resolution used by the application, the GPU may render display frame meeting the program setting resolution. Generally, the application may provide multiple default resolutions for the user to choose. The aforementioned default resolution may include 1080p, 720p, 2K, and so on.

In step S826, the processor 140 maps each light-emitting element to at least one pixel of the display frame according to the screen resolution, the program setting resolution, and the width and the height of the light-emitting apparatus 120. By mapping each light-emitting element to a pixel of the display frame, the processor 140 may determine the light-emitting color data according to the pixel data of the pixel mapped by each light-emitting element. For example, in different embodiments, according to the logical position of the light-emitting element E1 in FIG. 2, the processor 140 may map the light-emitting element E1 to a pixel or a pixel block on the display frame. Based on this, in an application scenario, when the portion of the display frame is mostly red, most of the light-emitting apparatuses 120 also provide color light with a relatively high red portion.

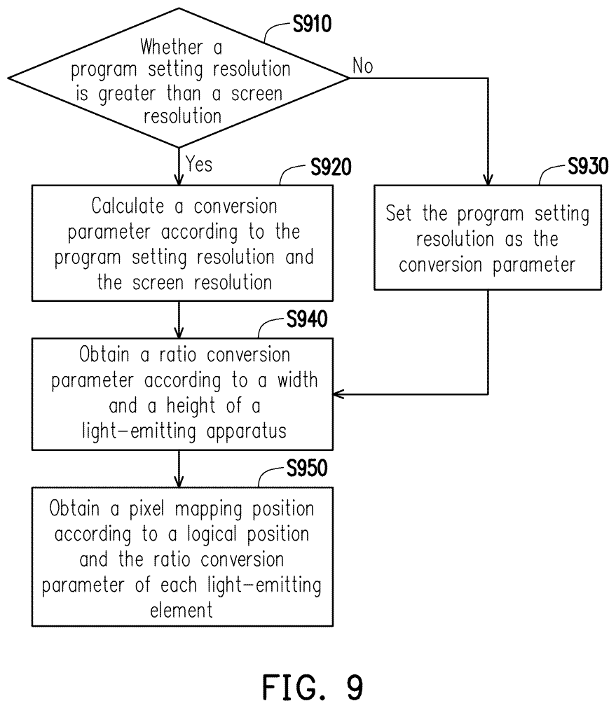

FIG. 9 is a flow chart of determining light-emitting color data of a light-emitting element according to an embodiment of the disclosure Referring to FIG. 9, in some embodiments, step S826 may be implemented as step S910 to step S950.

In step S910, the processor 140 determines whether the program setting resolution is greater than the screen resolution. If the determination in step S910 is yes, the processor 140 calculates a conversion parameter according to the program setting resolution and the screen resolution in step S920. If the determination in step S910 is no, the processor 140 sets the program setting resolution as the conversion parameter in step S930.

Afterwards, in step S940, the processor 140 obtains a ratio conversion parameter according to the width and the height of the light-emitting apparatus 120 and the aforementioned conversion parameter. In step S950, the processor 140 obtains a pixel mapping position of each light-emitting element according to the logical position and the ratio conversion parameter of each light-emitting element. Each light-emitting element may be mapped to a pixel of the display frame according to this pixel mapping position.

In an embodiment, the processor 140 may obtain a conversion parameter H2 and a conversion parameter W2 according to the program setting resolution and/or the screen resolution. If the program setting resolution W1*H1 is greater than the screen resolution W0*H0, then H2=H1*(H1/H0) and W2=W1*(W1/W0). On the other hand, if the program setting resolution W1*H1 is not greater than the screen resolution W0*H0, then H2=H1 and W2=W1. The width and the height of the light-emitting apparatus 120 are DW0*DH0. Afterwards, the processor 140 may obtain a ratio conversion parameter DH1 and a ratio conversion parameter DW1 according to the width and the height DW0*DH0 of the light-emitting apparatus 120 where, DW1=(W2/DW0), and DH1=(H2/DH0). Afterwards, according to the ratio conversion parameter DH1 and the ratio conversion parameter DW1, the processor 140 may map each light-emitting element to a pixel of the display frame according to the logical position of each light-emitting element.

In step S827, the processor 140 determines the light-emitting color data respectively corresponding to the light-emitting elements according to the mapping results of each light-emitting element. In some embodiments, the light-emitting elements include a first light-emitting element. When the first light-emitting element is mapped to a first pixel of the display frame, the light-emitting color data of the first light-emitting element is determined according to the pixel data of the first pixel. For example, the light-emitting color data of the first light-emitting element may be the same as the pixel data of the first pixel.

In step S830, the processor 140 controls each light-emitting element of the light-emitting apparatus 120 to emit the light according to the light-emitting color data of each light-emitting element. The detailed implementation of step S830 may refer to the description of the foregoing embodiments, and is not repeated herein.

In summary, according to the embodiments of the disclosure, the pixel data of the display frame may be captured from the image buffer, and the light-emitting color data of each light-emitting element disposed on the light-emitting apparatus may be determined according to the pixel data of the display frame, which makes each light-emitting element generate the color light according to the corresponding light-emitting color data. Based on this, the lighting effect color of the light-emitting apparatus may be matched with the display frame of the display apparatus, so that the light-emitting apparatus may provide the corresponding lighting effects based on the operating scenarios of the user, which greatly improves the user experience. In addition, the inference model may be updated correspondingly according to the operations of the user. Based on this, the lighting effect color of the light-emitting apparatus may meet the personalized needs of the user and provide the user with a unique lighting visual experience.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A lighting effect control method, adaptable for an electronic apparatus comprising a light-emitting apparatus, the method comprising:
capturing pixel data of a display frame of a display apparatus from an image buffer;
determining light-emitting color data respectively corresponding to a plurality of light-emitting elements of the light-emitting apparatus according to the pixel data of the display frame; and
controlling each of the plurality of light-emitting elements of the light-emitting apparatus to emit light according to the light-emitting color data of each of the plurality of light-emitting elements.

2. The lighting effect control method according to claim 1, wherein the step of capturing the pixel data of the display frame of the display apparatus from the image buffer comprises:
detecting a memory copy command associated with the image buffer; and
capturing the pixel data of the display frame from the image buffer in response to the memory copy command meeting a display condition.

3. The lighting effect control method according to claim 2, wherein the display condition comprises that a destination address of the memory copy command is a display front buffer.

4. The lighting effect control method according to claim 1, wherein the step of determining the light-emitting color data respectively corresponding to each of the plurality of light-emitting elements of the light-emitting apparatus according to the pixel data of the display frame comprises:
obtaining a window name corresponding to a focused window; and
determining the light-emitting color data respectively corresponding to each of the plurality of light-emitting elements of the light-emitting apparatus by an inference model according to the window name and the pixel data of the display frame.

5. The lighting effect control method according to claim 4, wherein an output of the inference model comprises one or a plurality of two-dimensional matrices, and a plurality of matrices in each of the plurality of two-dimensional matrices are color portions of the plurality of light-emitting elements respectively.

6. The lighting effect control method according to claim 4, wherein the method further comprises:
obtaining setting light-emitting color data respectively corresponding to the plurality of light-emitting elements in response to receiving a light-emitting color setting operation by a lighting setting utility, and controlling the plurality of light-emitting elements to emit the light according to the setting light-emitting color data; and
updating the inference model according to the setting light-emitting color data and the window name.

7. The lighting effect control method according to claim 1, wherein the step of determining the light-emitting color data respectively corresponding to each of the plurality of light-emitting elements of the light-emitting apparatus according to the pixel data of the display frame comprises:
obtaining a screen resolution of the display apparatus;
obtaining a program setting resolution of an application of the display frame;
mapping each of the plurality of light-emitting elements to at least one pixel of the display frame according to the screen resolution, the program setting resolution, and a width and a height of the light-emitting apparatus; and
determining the light-emitting color data respectively corresponding to each of the plurality of light-emitting elements according to mapping results of each of the plurality of light-emitting elements.

8. The lighting effect control method according to claim 7, wherein the plurality of light-emitting elements comprise a first light-emitting element, and when the first light-emitting element is mapped to a first pixel of the display frame, light-emitting color data of the first light-emitting element is determined according to pixel data of the first pixel.

9. The lighting effect control method according to claim 1, wherein the light-emitting apparatus comprises a light-emitting keyboard supporting human interface device (HID) specifications.

10. An electronic apparatus, comprising:
a display apparatus;
a light-emitting apparatus, having a plurality of light-emitting elements:
a storage apparatus, recording a plurality of commands; and
a processor, coupled to the display apparatus, the light-emitting apparatus, and the storage apparatus, and configured to:
capture pixel data of a display frame of the display apparatus from an image buffer;
determine light-emitting color data respectively corresponding to a plurality of light-emitting elements of the light-emitting apparatus according to the pixel data of the display frame; and
control each of the plurality of light-emitting elements of the light-emitting apparatus to emit light according to the light-emitting color data respectively corresponding to each of the plurality of light-emitting elements.

11. The electronic apparatus according to claim 10, wherein the processor is configured to:
detect a memory copy command associated with the image buffer; and
capture the pixel data of the display frame from the image buffer in response to the memory copy command meeting a display condition.

12. The electronic apparatus according to claim 11, wherein the display condition comprises that a destination address of the memory copy command is a display front buffer.

13. The electronic apparatus according to claim 10, wherein the processor is configured to:
obtain a window name corresponding to a focused window; and
determine the light-emitting respectively corresponding to each of the plurality of light-emitting elements of the light-emitting apparatus by an inference model according to the window name and the pixel data of the display frame.

14. The electronic apparatus according to claim 13, wherein an output of the inference model comprises one or a plurality of two-dimensional matrices, and a plurality of matrices in each of the plurality of two-dimensional matrices are color portions of the plurality of light-emitting elements respectively.

15. The electronic apparatus according to claim 13, wherein the processor is configured to:
obtain setting light-emitting color data respectively corresponding to the plurality of light-emitting elements in response to receiving a light-emitting color setting operation by a lighting setting utility, and control the plurality of light-emitting elements to emit the light according to the setting light-emitting color data; and
update the inference model according to the setting light-emitting color data and the window name.

16. The electronic apparatus according to claim 10, wherein the processor is configured to:
obtain a screen resolution of the display apparatus;
obtain a program setting resolution of an application of the display frame;
map each of the plurality of light-emitting elements to at least one pixel of the display frame according to the screen resolution, the program setting resolution, and a width and a height of the light-emitting apparatus; and
determine the light-emitting color data respectively corresponding to each of the plurality of light-emitting elements according to mapping results of each of the plurality of light-emitting elements.

17. The electronic apparatus according to claim 16, wherein the plurality of light-emitting elements comprise a first light-emitting element, and when the first light-emitting element is mapped to a first pixel of the display frame, light-emitting color data of the first light-emitting element is determined according to pixel data of the first pixel.

18. The electronic apparatus according to claim 10, wherein the light-emitting apparatus comprises a light-emitting keyboard supporting HID specifications.
